(19) United States
(12) Patent Application Publication
(10) Pub. No.: US 2005/0095317 A1
(43) Pub. Date: May 5, 2005

(54) Novel method for the production of fermented milk products

(75) Inventors: Claire Queguiner, Fontenay aux Roses (FR); Nathalie De Greeftrial, St. Maximin (FR); Fanny Grugier, Iffendic (FR); Denis Paquet, Clamart (FR)

Correspondence Address: NIXON & VANDERHYE, PC, 1100 N GLEBE ROAD, 8TH FLOOR, ARLINGTON, VA, 22201-4714, US

(73) Assignee: COMPAGNIE GERVAIS DANONE, Levallois-Perret (FR)

(21) Appl. No.: 10/504,593

(22) PCT Filed: Jan. 17, 2003
(86) PCT No.: PCT/FR03/00151

(30) Foreign Application Priority Data
Feb. 15, 2002 (FR) 02 01962

(51) Int. Cl. A23C 9/12

(52) U.S. Cl. 426/34

(57) ABSTRACT

The invention relates to a novel method for producing fermented milk products, according to which at least one casein of the milk, i.e. at least the kappa casein, is proteolyzed by means of a coagulating enzyme of the milk, e.g. chymosin, and the product is stirred after fermenting. The inventive method is particularly suitable for the production of fermented milk products such as yogurt and fermented types of milk, wherein said products are provided with an improved texture, especially an improved viscosity, without causing syneresis.

The present patent application relates to a novel method for the manufacture of fermented dairy products, and to the novel products thus obtained. This novel method is more particularly suitable for the manufacture of yogurts and fermented milks.

It indeed has the advantage of improving the texture of such dairy products, and in particular of increasing the viscosity, without as a result inducing a phenomenon of syneresis (exudation of milk serum) which would be unacceptable for a fermented dairy product of the yogurt or fermented milk type. This remarkable result is, in accordance with the present invention, obtained by subjecting to proteolysis at least one milk casein, namely at least kappa-casein, and by stirring the product after fermentation.

To improve the texture of fermented dairy products of the yogurt or fermented milk type, the procedure is currently carried out by concentrating the milk substrate, or by adding products derived from milk, and in particular by adding proteins such as caseinate, milk serum proteins, or by adding texturizing agents (thickeners, gelling agents) such as starch, pectin, or gelatin.

The proteolysis of casein in general, and of kappa-casein in particular, was not, in the prior art, a desired phenomenon during the manufacture of fermented dairy products of the yogurt and fermented milk type. Indeed, caseinolytic enzymes, such as for example that which is contained in rennet, and which is used for the manufacture of cheeses and fromages frais, were known, because of their coagulating effect, to induce substantial phenomena of syneresis. However, while the formation of whey and milk serum is sought and necessary for the manufacture of cheeses and fromage frais (recovering of the curd), it is on the other hand not desirable during the manufacture of yogurts and fermented milks because it leads to a texture which is not acceptable for this type of dairy products (granular texture, substantial exudation of milk serum). Accordingly, up until now, caseinolytic enzymes were not used during the manufacture of yogurts and fermented milks, and care was even taken to avoid such enzymes being present or produced in the milk substrate.

The method according to the invention proposes, by contrast, to produce fermented dairy products of the yogurt and fermented milk type in which at least one milk casein, namely at least kappa-casein, is substantially proteolyzed. The carrying out of such a proteolysis during the manufacture of fermented dairy products of the yogurt and fermented milk type runs counter to the prejudices of persons skilled in the art.

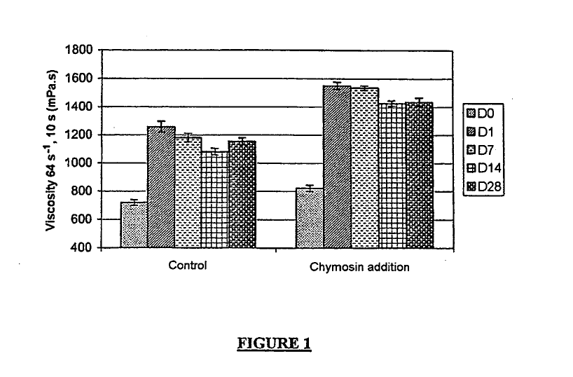

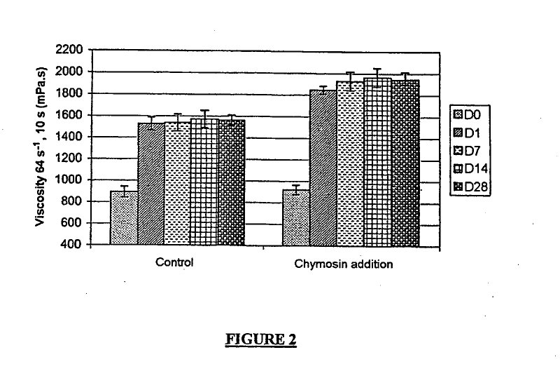

As a guide, there may be mentioned for example the article Schkoda et al. 2001 (“Influence of the protein content on structural characteristics of stirred fermented milk”, Milchwissenschaft 56(1):19-22), which describes trials intended to evaluate the influence of the content of milk proteins on the structural characteristics of various products derived from lactic acid fermentation. For that, lactic acid fermentations are carried out on nanofiltered milk, so as to cause the protein content to vary from 3.5 to 7.0% in the same milk. In order to model a yogurt production, on the one hand, and a fromage frais production, on the other hand, part of the trials is carried out in the absence of rennet (modeling of the manufacture of yogurt), and the other part in the presence of rennet at a low dose (modeling of the manufacture of fromage frais, with 0.8 ml of rennet P99, 179 IMCU/ml, per 100 kg of milk or of milk concentrate at pH 6.4, which in fact corresponds to a dose of 0.7 microgram of active enzymes per 100 kg of milk). The choice of such modeling clearly illustrates the fact that persons skilled in the art did not envisage a priori adding rennet during the manufacture of yogurt type products. In addition, the results reported in this article demonstrate that while rennet makes it possible, in the fromage frais model (nanofiltered milk+rennet), to very slightly increase the viscosity of the product when the substrate has a very high concentration of proteins (concentration greater than 6%; cf. Figure 2 from Schkoda et al. 2001), it nevertheless leads to a very high decrease in the capacity to retain the milk serum (cf. Figure 1 from Schkoda et al. 2001). Such syneresis results which, what is more, combined with the fact that, in order to manufacture yogurts and fermented milks, milk substrates are indeed used whose protein content is less than or equal to 6%, therefore reinforce the conviction of persons skilled in the art according to which caseins must not be proteolyzed during the manufacture of fermented dairy products of the yogurt or fermented milk type.

The proteolysis of milk was therefore considered in the prior art as a source of technological problems and of defects in milk and dairy products, such as the formation of a fragile curd accompanied by syneresis during the manufacture of yogurts (Tamine & Robinson 1985, “Yoghurt—Science and Technology”, Ed. Woodhead Publishing Ltd 1999, cf. page 17), and gelling of milk during UHT heat treatment (Stephaniak & Sorhaug 1995, Thermal denaturation of bacterial enzymes in milk. International dairy federation bulletin “Heat induced changes in milk”, 1, p. 349-363).

By going completely against prior art technical prejudices, the inventors, for their part, propose, in order to manufacture fermented dairy products of the yogurt and fermented milk type, to proteolyze at least one of these caseins naturally contained in the milk, namely at least kappa-casein, and to stir the product obtained after fermentation. The inventors indeed demonstrate that these means make it possible, surprisingly and unexpectedly, to improve the texture, and in particular to increase the viscosity of yogurts and fermented milks, without as a result inducing syneresis which would be unacceptable for such fermented dairy products.

In the present application, the terms “yogurts” and “fermented milks” have their customary meanings. More particularly, these names correspond to those defined in France by Decree No. 88-1203 of 30 Dec. 1988 (published in the Official Journal of the French Republic of 31 Dec. 1988). The text of this decree is reproduced below, at the end of the description, following the examples.

To obtain a “yogurt or fermented milk” product as defined in the said French decree, and therefore as referred to in the present patent application, it is recalled in particular that there must not be elimination of milk serum and that there must be a heat treatment at least equivalent to pasteurization. A standard pasteurization treatment is for example a treatment at 92-95° C. for 5 to 10 minutes. Because of the application of a heat treatment which is at least equivalent to standard pasteurization, the milk serum proteins of the milk substrate are denatured overall (from 25 to 99% of them, approximately).

The present patent application therefore relates to a novel method for the manufacture of fermented dairy products, and in particular yogurts and fermented milks, characterized in that it comprises the following steps:
a milk substrate whose protein content is different from zero, but less than or equal to 6%, is subjected to lactic acid fermentation and to kappa caseinolysis so as to obtain, at the end of lactic acid fermentation, a kappa caseinolysis level equal to or greater than 20%, preferably equal to or greater than 50%, more preferably equal to or greater than 70%, most preferably equal to or greater than 80%, and in that
said substrate is stirred after lactic acid fermentation and kappa-caseinolytic treatment.

Advantageously, said kappa caseinolysis occurs at least partly concomitantly with said lactic acid fermentation. As presented in greater detail below, said kappa-caseinolytic enzyme may be added or supplied after said heat treatment (for example at the end of or during lactic acid fermentation), or alternatively before or at the start of said heat treatment, but in the latter case, care should be taken not to induce precipitation during this heat treatment.

The expression “kappa caseinolysis” or “kappa-caseinolytic treatment” is understood here to mean proteolysis of kappa-casein. Likewise, the term “kappa-caseinolytic enzyme” refers to an enzyme capable of proteolyzing kappa-casein.

As milk naturally contains kappa casein, and naturally has a protein content different from zero, any type of milk substrate is a priori suitable for carrying out the present invention. There will of course nevertheless be chosen a milk substrate which, insofar as it is intended for the manufacture of yogurts and fermented milks, has a protein content (before fermentation) of less than or equal to 6%. Preferably a milk substrate will be chosen whose protein content is between 3 and 5% inclusive, more preferably between 3.4 and 5%, still more preferably between 3.6 and 4.8%. A conventional method for measuring the protein content of a milk substrate consists in measuring the total nitrogen content, and in subtracting the nonprotein nitrogen content using the Kjeldahl method described in “Science du lait—Principes des techniques laitières”, fourth edition, 1984, by C. Alais (Ed. SEPAIC), pages 195-196.

The term milk substrate is understood to have here its customary meaning for the manufacture of fermented dairy products of the yogurt and fermented milk type, that is to say any substrate whose composition is suitable for carrying out a lactic acid fermentation for the manufacture of yogurts and fermented milks suitable for human consumption. Generally, the milk substrate used in fact corresponds to milk as collected (for example cow's, ewe's and goat's milk) which has been optionally pasteurized and/or skimmed. Most generally, and in particular in industry, the composition of milk is additionally “standardized” by the addition of products derived from milk, such as skim milk powder, and/or dairy protein powders (caseinates or WPC), and/or fats (cream for example). The milk substrates referred to for the present invention therefore in fact most generally have a composition which corresponds either to that of milk as collected, or to that of standardized milk, and may have been prepasteurized (75° C. for 20 to 30 s) and/or skimmed.

The novel method in accordance with the invention may be carried out for any lactic acid fermentation. The steps of a lactic acid fermentation method may be conventionally schematically presented as follows:
after collection, the milk is generally prepasteurized at 75° C. for 10 to 30 seconds, skimmed and stored up to the time of use by refrigerated storage,
the skim milk is standardized in relation to proteins by methods known to a person skilled in the art, in particular by addition of skim milk powder, dairy protein powders (caseinates or WPC) and optionally in relation to fat (for example cream), so as to obtain the desired composition,
after rehydration of the powders, with stirring for 30 min to 1 hour, the milk mixture thus obtained is subjected to a pasteurization heat treatment at a temperature of 92 to 95° C. for 5 to 10 min and then to homogenization under a so-called descending phase pressure; alternatively, the homogenization may be carried out before the heat treatment, it is then termed ascending phase,
the milk mixture is then cooled to a temperature 1 or 2 degrees higher than that for fermentation, and is inoculated with a lactic acid bacterium; the fermentation is carried out according to conventional procedures, it is stopped at a pH of between 4 and 5, preferably between 4.5 and 4.7.

When the milk mixture is inoculated with a ferment composed of strains of Lactobacillus bulgaricus and Streptococcus thermophilus, the product is a yogurt. When the milk mixture is, in addition to the preceding strains, inoculated with other species of lactic acid bacteria, in particular Bifidobacterium, Lactobacillus acidophilus, Lactobacillus casei or Lactobacillus helveticus, the finished product is a fermented milk.

The kappa-caseinolysis should be carried out in a controlled manner, that is to say that the primary proteolysis reaction should not consist in hydrolyzing the casein into its different constituent amino acids, but in hydrolyzing the casein into fragments of the size of a peptide, a polypeptide or a protein. This of course does not exclude these fragments from being able, once produced by controlled kappa caseinolysis, to then be modified and/or hydrolyzed during the process. Initially, however, the kappa caseinolysis which is carried out in accordance with the present invention leads to the release of at least one peptide, polypeptide or protein fragment, and not to a set of individual amino acids. For this, there will be used, in accordance with the present invention, a kappa-caseinolytic agent which moreover has the property of coagulating milk, that is to say the property of destabilizing the micelle, and thus inducing the coagulation of the milk. A conventional method for determining if an agent has the property of coagulating milk is the Berridge test (standard 176:1996 of the International Dairy Federation, 41, square Vergote, B-1040 Brussels), or the modified Berridge test (without addition of CaCl₂ to the milk tested).

By way of illustration, such agents generally release, from kappa-casein, at least one C-terminal fragment whose size is less than or equal to 10 kDa, preferably less than or equal to 8 kDa.

To carry out a kappa caseinolysis in a food medium, a kappa-caseinolytic enzyme is advantageously used. To carry out a controlled kappa caseinolysis, as indicated above, a kappa-caseinolytic enzyme will be preferably chosen which has the property of coagulating milk.

Such enzymes may be of various origins, for example of animal, microbial or plant origin.

The predominant enzyme in rennet (calf, cow or pig rennet), namely chymosin, has the advantageous property of hydrolyzing kappa-casein at the level of the Phe-Met bond (residues 105-106) to release two polypeptide fragments: a C-terminal peptide of the caseinomacropeptide type (CMP: 7.2 kDa) and an N-terminal residual part of the para-kappa-casein type (PKC: 11.8 kDa). Chymosin, and any kappa-caseinolytic enzyme which, in a manner comparable to chymosin, hydrolyzes kappa-casein at the level of the Phe-Met bond (residues 105-106) or in an environment close to this bond (for example hydrolysis inside the region defined by residues 95 to 115), thus releasing a polypeptide of the CMP type and a polypeptide of the PKC type, are examples of advantageous appropriate enzymes for carrying out the invention. Rennet and chymosin can be obtained from numerous suppliers, such as for example Chr. Hansen, 2970 Horsholm, Denmark for rennet, and DMS Food Specialties 2600 MA Delft, The Netherlands for chymosin (marketed under the trade mark Maxiren®).

Kappa-caseinolytic enzymes equivalent to chymosin exist, for example enzymes of fungal origin which, for their part, hydrolyze kappa-casein at the level of the Phe-Met bond (residues 105-106) or in a neighboring environment (region 95-115 for example). This is in particular the case for the Rhizomucor miehei acid protease more widely known under the trade mark Fromase®, available from DSM Foods Specialties (2600 MA Delft, The Netherlands).

Another example of an advantageous appropriate caseinolytic enzyme is an enzyme of plant origin, namely cardosin extracted from cardoon.

Preferably, a coagulating kappa-caseinolytic enzyme will therefore be chosen which hydrolyzes kappa-casein at a level of the Phe-Met bond (residues 105-106), or in a neighboring environment such as the region defined by residues 95-115.

The kappa-caseinolytic enzyme may be provided in purified form, in the form of a biological extract containing such an enzyme mixed with other compounds or of a protein extract of a microbiological culture medium, or in the form of a microorganism producing such an enzyme. For example, in the case of chymosin, this enzyme may be brought to the milk substrate in purified form, or in the form of a biological extract such as rennet (for example calf abomafum), that is to say a nonpurified mixture of chymosin and small quantities of pepsin). It is also possible to obtain chymosin from microorganisms capable of producing the enzyme as a result of genetic transformation. An example of a microorganism modified by transfection of the gene which encodes bovine chymosin is a yeast (Kluveromyces lactis) which produces the chymosin marketed by DSM Food Specialties (2600 MA Delft, The Netherlands) under the trade mark Maxiren®. Aspergillus niger has also been modified by transfection of the gene encoding chymosin; the chymosin produced by this microorganism is marketed under the trade mark Chy-Max® by Chr. Hansen.

The choice of the kappa-caseinolytic enzyme and of the time for its addition to the milk substrate of course depends on temperature and pH conditions for this substrate. It is indeed possible to choose to add the enzyme, or to trigger its production, at any time of the method of manufacture between the moment of collection of the milk and the end of the lactic acid fermentation, for example after the skimming and prepasteurization stage which is generally performed on the collected milk during the refrigeration stage, during standardization of the milk or after pasteurization, for example during cooling, inoculation of the lactic acid bacteria, or during the lactic acid fermentation. It is therefore necessary to choose an enzyme which is active at the pH and at the temperature at which the substrate in question is present (and will be present), or choose the time for adding a given enzyme according to the pH values and temperatures at which this enzyme is active. Persons skilled in the art will preferably choose, for a better yield, pH values and temperatures which correspond to the pH values and temperatures for optimum activity of the enzyme. When the enzymes are provided in the form of enzyme-producing microorganisms, it is of course preferable to add these microorganisms before or during a stage during which the milk is placed under conditions, and in particular temperature and pH conditions, which promote their metabolism and in particular promote the production of proteases.

In the particular case of chymosin, which is not thermoresistant, the addition of enzyme or of an enzyme source, or where appropriate the initiation of its production, is preferably carried out after the pasteurization stage, for example at the beginning of or during lactic acid fermentation. Advantageously, the chymosin is added (or where appropriate its production is triggered) at the end of the lag phase of the slactic acid fermentation (the pH is then between pH 6.4 and 5.9, preferably it is 6.3; the temperature, for its part, is between 37° C. and 43° C.).

If a thermoresistant enzyme is used (that is to say an enzyme which would only be partially or not at all inactivated by a treatment of the pasteurization type at 95° C. for 5 to 10 min), then the addition or the initiation of enzymatic production may be made before pasteurization, for example during the refrigerated storage of the collected milk (which may have been skimmed and/or prepasteurized), or during the standardization of the milk.

The appropriate dose of enzymes to be added, or where appropriate to cause to be produced, of course depends, for its part, on the initial kappa-casein content of the substrate and the activity of the enzyme at the pH and at the temperature chosen.

In accordance with the present invention, it is necessary to obtain a kappa caseinolysis level of at least 20%. This 20% level is a minimum threshold, but higher levels (up to 100%) are preferred. It should however be noted that in the case where the kappa caseinolysis might be carried out before pasteurization, it would then be advantageous to be limited to a kappa caseinolysis level of less than or equal to 70% before pasteurization, this being in order to avoid precipitation phenomena during pasteurization.

Persons skilled in the art will know how to carry out the adjustments necessary for each particular case considered (pH, temperature, dose) in order to obtain the desired level of caseinolysis. For example, in the case of chymosin added at the end of the lag phase of the lactic acid fermentation, that is to say at a time when the pH is only very slightly acidic or where the temperature will no longer exceed about 43° C., it will be possible to add the chymosin at a dose of 1 to 7 micrograms, preferably 2 to 7 micrograms of pure active enzyme per gram of kappa-casein contained in the milk substrate.

To measure the level of kappa caseinolysis in a milk substrate, persons skilled in the art have available standard techniques such as for example the electrophoretic method described by Recio et al. 1997 (“Application of electrophoresis to the study of proteolysis of caseins”, J. Dairy Res. 64:221-230). The kappa caseinolysis level may thus be evaluated by measuring the reduction in the surface area of the kappa-casein peak observed after enzymatic treatment in relation to the surface of the kappa-casein peak observed before enzymatic treatment. It should be noted that at the end of the method according to the invention, not all the kappa-casein fragments which were produced by kappa caseinolysis are generally found; it is likely that these fragments are partly used as nutrients by the growing lactic acid bacteria. Accordingly, it is recommended to monitor the decrease in the kappa-casein peak, rather than the appearance of kappa caseinolysis fragments (such as the appearance of CMP in the case where the enzyme used cuts the kappa-casein at the level of the Phe-Met bond—residues 105-106).

In addition to kappa caseinolysis, the method according to the invention comprises stirring the fermented product. This stirring may be carried out according to conventional techniques, such as smoothing by passing through a filter (“Yoghurt science and Technology”, by A. Y. Tamine and R. K. Robinson, Ed. Woodhead Publishing Ltd. 1999).

The method according to the invention has the advantage of allowing the manufacture of fermented dairy products of the yogurt and fermented milk type whose texture is improved compared with yogurts and fermented milks manufactured in a comparable manner, but without kappa caseinolysis at at least 20% and/or without stirring. It makes it possible in particular to manufacture yogurts and fermented milks whose apparent viscosity (as measured at 64 s⁻¹, 10 s and at 10° C. on a coaxial cylinder viscometer) is increased by 20% to 70% compared with the control yogurts and fermented milks. This method therefore makes it possible to limit, or even avoid, the addition of texturizing agents (such as gelatin, starch or pectin) which is currently performed in order to confer the appropriate texture on the products of the fermented milk and yogurt type. It also makes it possible to limit the protein content of the milk substrate used: the milk substrate may have a lower protein concentration while preserving a satisfactory apparent viscosity result. For example, the inventors have been able to demonstrate that, in order to obtain the apparent viscosity value which is obtained by applying the method according to the invention to a milk mixture containing 4.1% of proteins, it would be necessary, in the absence of kappa-caseinolytic treatment, to increase the protein content of the milk substrate to 4.9%. With the method according to the invention, the manufacture of dairy products of the yogurt and fermented milk type requires less texturing agents and proteins for an equivalent result in terms of texture.

In a particularly remarkable manner, the method according to the invention does not lead to phenomena of syneresis which would be unacceptable for a product of the fermented milk or yogurt type. Thus, the inventors were able to observe the absence of any phenomena of decantation or exudation, even after 28 days of storage at 10° C. The products obtained also have and preserve a perfectly smooth and homogeneous texture.

The present application also relates to fermented milks and yogurts which can be obtained by the method according to the invention. The fermented milks and yogurts obtained by the method according to the present invention are characterized in particular by a kappa-casein content which is substantially less than the kappa-casein content normally observed in comparable products of the prior art. When they are derived from milk or a milk substrate which has been subjected to a heat treatment at least equivalent to standard pasteurization (for example 5-10 min at 92-95° C.), the serum proteins of the finished product are denatured overall (from 25 to 99% of serum proteins denatured approximately). More particularly, the yogurts and fermented milks according to the invention are characterized by a kappa caseinolysis level of at least 20%, preferably of at least 50%, more preferably of at least 70%, very preferably of at least 80%. This kappa caseinolysis level can be evaluated by capillary electrophoresis according to the method of Recio et al. 1997 (“Application of electrophoresis to the study of proteolysis of caseins”, J. Dairy Res. 64:221-230), using the fact that the surface area of the kappa-casein peak decreases during the manufacture of the yogurts and fermented milks prepared according to the method of the invention, and with reference to a standard peak, such as the peak for a reference compound whose content does not significantly vary during the method. If the kappa-caseinolytic enzyme used is chymosin, the alpha-casein peak S1 can serve as standard peak. The following calculation therefore makes it possible to evaluate the kappa caseinolysis level of a fermented milk prepared according to the method of the invention:
kappa caseinolysis level (%)=1−((a_{κe}*a_{αst}/a_{αse})/a_{κt}))*100
with:
a_{κe}=area of the kappa-casein peak for the yogurt sample
a_{κt}=area of the kappa-casein peak for a control milk
a_{αse}=area of the peak for the reference compound of the yogurt sample (alpha-casein S1 peak in the case of chymosin)
a_{αst}=area of the peak for the reference compound of a control milk (alpha-casein S1 peak)

The expression control milk is understood to mean a bulk-blended milk which has been skimmed and prepasteurized (75° C.-10 to 30 s).

Alternatively, if the significant presence of a kappa-caseinolytic enzyme, such as for example the significant presence of chymosin, is detected in yogurt or a fermented milk, it can be deduced therefrom that this yogurt or fermented milk is in conformity with the present invention. For example, the significant presence of chymosin can be determined with the aid of an anti-chymosin antibody (Boudjellab N., Rolet-Repecaud O. and Collin J. C., 1994, “Detection of residual chymosin in cheese by enzyme-linked immunosorbent assay”, J. Dairy Research 61:101-109).

Persons skilled in the art will find in the book “Yogurt—Science and Technology”, 2^{nd} edition, by A. Y. Tamine and R. K. Robinson (Woodhead Publishing Ltd), the content of which is incorporated into the present application by reference, a source of valuable technical information for carrying out the embodiments of the invention.

The examples which follow are given purely by way of illustration, and refer to FIGS. 1 and 2, each of which present the apparent viscosity values (64 s⁻¹, 10 s, coaxial cylinder viscometer) measured in mPa·s on the control fermented milks (five bars on the left) and on the fermented milks obtained by chymosin treatment in accordance with the invention (five bars on the right): for each of the two groups of fermented milks, the apparent viscosity measurements made on D0 (apparent viscosity measurement made at 20° C.), and then on D1, D7, D14 and D28 (apparent viscosity measurement made at 10° C.) are presented from left to right.

### EXAMPLE 1

Bulk-blended milk obtained from direct collection from producers, skimmed, prepasteurized and cooled to 4° C. beforehand, is standardized in relation to proteins (4.3%) and fat (3.2%) with the aid of skim milk powder and cream. The milk substrate thus prepared is subjected to pasteurization (95° C.-8 min), and then to homogenization. After cooling to 44° C. and then inoculating with a lactic acid bacterium (pure strains of Streptococcus thermophilus and Lactobacillus bulgaricus, obtained from Chr. Hansen, fermentation temperature 43° C., fermentation time=4 h 30 min), the milk substrate is supplemented with a dose of chymosin Maxiren® at 120 IMCU/g marketed by DSM (1 μg of chymosin per 100 g of milk mixture, that is 2.3 μg of enzyme/g of kappa-casein).

When pH 4.6 is reached, the curd is withdrawn from the fermentation tank so as to be subjected to smoothing by passing through a filter, and the stirred product is subjected to cooling to 20° C., in a plate exchanger, and then packaged in 125 ml pots, stored at 4° C. overnight, and then at 10° C. for 28 days.

The results of apparent viscosity (64 s⁻¹, after 10 s, coaxial cylinders viscometer) measured during refrigerated storage of a fermented milk of the yogurt type, supplemented or otherwise with chymosin at the start of fermentation, are presented in FIG. 1. The error bars represent the 95% confidence intervals.

In addition to a large increase in its viscosity compared with the control, the product prepared in the presence of chymosin exhibits no exudation phenomenon, even after 28 days storage at 10° C. Its texture in the mouth is described by tasters as being particularly unctuous and coating. No taste defect was detected. The presence of chymosin during fermentation absolutely does not modify the kinetics of acidification.

### EXAMPLE 2

Bulk-blended milk, skimmed and prepasteurized and cooled to 4° C. beforehand, is standardized in relation to proteins (4.5%) and fat (2.1%) with the aid of skim milk powder and cream. The milk substrate thus-prepared is subjected to pasteurization (95° C.-8 min), and then to homogenization. After cooling to 39° C., the milk substrate is inoculated with a lactic acid bacterium (pure strains of Streptococcus thermophilus and Lactobacillus bulgaricus obtained from Chr. Hansen, fermentation temperature=38° C., fermentation time=7 h 30 min). Chymosin (Maxiren® at 120 IMCU/g from DSM) is added during fermentation (pH 6.2) at the rate of 1.5 μg of chymosin per 100 g of milk mixture, that is 3.3 μg of enzyme/g of kappa-casein.

When pH 4.6 is reached, the curd is withdrawn from the fermentation tank so as to be subjected to smoothing by passing through a filter, and the stirred product is subjected to cooling to 20° C., in a plate exchanger, and then packaged in 125 ml pots, stored at 4° C. overnight, and then at 10° C. for 28 days.

The results of apparent viscosity (64 s⁻¹, after 10 s, coaxial cylinders viscometer) measured during refrigerated storage of a fermented milk of the yogurt type, supplemented or otherwise with chymosin during fermentation (pH=6.2), are presented in FIG. 2. The error bars represent the 95% confidence intervals.

In the same manner as in the preceding example, the product prepared in the presence of chymosin exhibits no exudation phenomenon, even after 28 days storage at 10° C. Its texture in the mouth is described by tasters as being particularly unctuous and coating compared with the control. No taste defect was detected. The presence of chymosin during fermentation does not modify the kinetics of acidification.

Decree No. 88-1203 of 30 Dec. 1988 Decree relating to fermented milks and yogurt NOR:ECOC8800150D

The Prime Minister,
on the report of the Minister of State, Minister for Economic Affairs, Finance and the Budget, Lord Chancellor, Minister of Justice, Minister of Agriculture and Forestry and Minister of Solidarity, Health and Social Welfare, Government spokesperson, in the matter of the law of 1 Aug. 1905 on fraud and misrepresentation concerning products or services, and in particular its article 11, with the amended decree of 22 Jan. 1919 taken for application of said law; in the matter of the law of 29 Jun. 1934 relating to the protection of dairy products;
in the matter of the law of 2 Jul. 1935 designed for the organization and improvement of the milk market;
in the matter of the amended decree of 15 Apr. 1912 applying the abovementioned law of 1 Aug. 1905 as regards foodstuffs;
in the matter of the amended decree of 25 Mar. 1924 applying the law of 1^{st} Aug. 1905 as regards milk and dairy products;
in the matter of Decree No. 84-1147 of 7 Dec. 1984 applying the abovementioned law of 1^{st} Aug. 1905 as regards the labeling and presentation of foodstuffs; having heard the counsel of state (department of finance),

### Article 1

The name “fermented milk” is reserved for the dairy product prepared with skim milk or unskimmed milks or concentrated milks or skim milk or unskimmed milk powder, enriched or not enriched with constituents of milk, which has been subjected to heat treatment at least equivalent to pasteurization, inoculated with microorganisms belonging to the species characteristic of each product.

The coagulation of fermented milks should not be obtained by other means than those which result from the activity of the microorganisms used.

The quantity of free lactic acid which they contain should not be less than 0.6 gram per 100 grams during sale to the consumer and the content of protein matter expressed in relation to the milk-containing part should not be less than that of a normal milk.

Fermented milks must be kept, up to the time of sale to the consumer, at a temperature capable of avoiding their spoilage and will be set by a joint order of the ministers responsible for agriculture, health and consumer affairs.

### Article 2

The name “yogurt” is reserved for the fermented milk obtained, according to fair and traditional practices, by the development of specific thermophilic lactic acid bacteria alone, called Lactobacillus bulgaricus and Streptococcus thermophilis, which must be inoculated simultaneously and be live in the finished product, at the rate of at least 10 million bacteria per gram expressed in relation to the milk-containing part. The quantity of free lactic acid contained in yogurt should not be less than 0.7 gram per 100 grams during sale to the consumer.

### Article 3

Fermented milks may be supplemented with the following products: flavor extracts, natural flavorings and, within a limit of 30 p. 100 by weight of the finished product, sugars and other foodstuffs which confer a specific flavor.

The incorporation, as substitutes, of fats and protein materials of nonmilk origin is forbidden.

They must not be subjected to any treatment allowing a constituent component of the milk used to be removed, in particular draining of the coagulum.

Orders issued in the forms provided for in the 1^{st} article of the abovementioned decree of 15 Apr. 1912 state the list and the conditions for use of the other substances and the other categories of flavorings authorized for the manufacture and the preparation of the products defined in the present decree.

### Article 4

### Amended by Decree 97-298 1997-03-27 Art. 2 JORF 3 Apr. 1997

The labeling of fermented milks comprises, in addition to the notes provided for by articles R.112-6 to R.112-31 of the abovementioned consumer code:
in addition to the trade name, information on the animal species from which the milk is derived, as long as this is not cow's milk;
the note “preservation at . . . ” followed by information on the temperature to be observed;
the note “low-fat” following the trade name if the fat content of the product, calculated on the milk-containing part, is less than 1 p. 100 by weight;
depending on the case, the note “sweetened” or the name of the flavoring material used if the fermented milk is sweetened or flavored;
in case of addition of one or more ingredients provided for in article 3, a note of this or these ingredients must be attached to the trade name.

The labeling of fermented milks may contain the note “fat”, accompanying the trade name, if the fat content, calculated on the milk-containing part, is at least equal to 3 p. 100 by weight.

### Article 5

The name “yogurt” can only appear on the label for a foodstuff if the product involved contains “yogurt” in conformity with the definition provided for in article 2 above.

### Article 6

A joint order by the ministers responsible for agriculture, health and consumer affairs sets, where appropriate, the period for which the products defined in the present decree preserve their specific properties.

### Article 7

### Amended by Decree 97-298 1997-03-27 Art. 2 JORF 3 Apr. 1997

Independently of the expected measurements for searching for and possibly establishing fraud offences in application of articles R.215-1 to R.215-15 of the consumer code, the microbiological characteristics of fermented milks and the modalities for checking these characteristics are set by a joint order of the ministers responsible for agriculture, health and consumer affairs.

### Article 8

### Amending Article(s)

### Article 9

The Minister of State, Minister for Economic Affairs, Finance and the Budget, Lord Chancellor, Minister of Justice, Minister of Agriculture and Forestry and Minister of Solidarity, Health and Social Welfare, Government spokesperson, and the Secretary of State to the Minister of State, Minister of Economic Affairs, Finance and the Budget, responsible for consumer affairs, are each, as applies to them, responsible for implementing the present decree, which will be published in the Official Journal of the French Republic.

1. A method for the manufacture of a dairy product chosen from the group consisting of fermented milks and yogurts, characterized in that:
a milk substrate whose protein content is different from zero but less than or equal to 6% is subjected to a heat treatment at least equivalent to pasteurization, to lactic acid fermentation and to kappa caseinolysis with the aid of an enzyme chosen from the group of kappa-caseinolytic enzymes which have the property of coagulating milk, so as to obtain at the end of lactic acid fermentation a kappa caseinolysis level equal to or greater than 20%, said kappa caseinolysis being initiated between the collection of the milk and the end of the lactic acid fermentation, provided that if it is initiated before said heat treatment, care will then be taken not to induce precipitation during this heat treatment, and in that:
said substrate is stirred after lactic acid 25 fermentation and kappa-caseinolytic treatment.

2. The method as claimed in claim 1, characterized in that the protein content of the milk substrate is between 3 and 5% inclusive.

3. The method as claimed in claim 1, characterized in that the kappa caseinolysis level is equal to or greater than 50%.

4. The method as claimed in claim 1, characterized in that the kappa caseinolysis level is equal to or greater than 70%, preferably equal to or greater than 80%.

5. The method as claimed in claim 1, characterized in that said coagulating kappa caseinolysis enzyme is provided in purified form, or in the form of a biological extract or a protein extract of a microbiological culture medium, or in the form of a microorganism producing such an enzyme.

6. The method as claimed in claim 1, characterized in that said coagulating kappa caseinolysis enzyme proteolyzes the kappa-caseins at the level of the Phe-Met bond (residues 105-106)

7. method as claimed in claim 1, characterized in that said coagulating kappa caseinolysis enzyme is chymosin.

8. The method as claimed in claim 7, characterized in that the chymosin is brought to the milk substrate in the form of rennet.

9. The method as claimed in claim 1, characterized in that said coagulating kappa caseinolysis enzyme is the Rhizomucor miehei acid protease.

10. The method as claimed in claim 8 or 9, characterized in that the chymosin is provided at the end of the lag phase of the lactic acid fermentation.

11. The use of an enzyme chosen from the group of kappa-caseinolytic enzymes which have the property of coagulating milk, for the manufacture, by heat treatment at least equivalent to pasteurization, by lactic acid fermentation and by kappa caseinolysis, of a stirred dairy product chosen from the group consisting of fermented milks and yogurts, said kappa caseinolysis being initiated between the collection of the milk and the end of the lactic acid fermentation, provided that if it is initiated before said heat treatment, care is then taken not to induce precipitation during this heat treatment.

12. A stirred dairy product chosen from the group consisting of fermented milks and yogurts which can be obtained from a milk pasteurized at a temperature of between 92 and 95° C. for 5 to 10 mm, characterized in that its kappa caseinolysis level is greater than or equal to 20% relative to the skimmed and prepasteurized bulk-blended milk.

13. A stirred dairy product chosen from the group consisting of fermented milks and yogurts, which can be obtained by the method as claimed in claim 1.
